(19) United States
(12) Patent Application Publication
(10) Pub. No.: US 2015/0262419 A1
(43) Pub. Date: Sep. 17, 2015

(54) Stereoscopic 3D display model and mobile device user interface systems and methods

(71) Applicant: Shalong Maa, Arlington, TX (US)

(72) Inventor: Shalong Maa, Arlington, TX (US)

(21) Appl. No.: 13/999,618

(22) Filed: Mar. 13, 2014

(51) Int. Cl. G06T 17/10

(52) U.S. Cl. CPC G06T 17/10; G06T 2219/2008

(57) ABSTRACT

Disclosed herein are methods and systems for constructing a S3DD model comprising a pre-determined primary 3D model and a secondary 3D model obtained by modifying a copy of said primary model. Said modification is done by displacing said copy from the primary model by an amount of DMD and by rotating said copy relative to said primary model by an amount of DMAS. The values of the DMD and DMAS are obtained through geometry analysis based on the virtual 3D position of the object image behind the display relative to the physical 3D positions of the viewer's two eyes. In case of displaying the 3D image of a large object, its primary 3D model and the copy shall be divided into many small sub-models, with each sub-model being treated as an isolated or independent model with respect to calculations of the values of DMD and DMAS.

This is a continuation-in-part application of application Ser. No. 13/694,523 filed Dec. 10, 2012, of which the complete disclosures are incorporated fully herein by reference.

### TECHNICAL FIELDS

The first part of the present invention pertains generally to digital 3D modeling and stereoscopic 3D display. The second part of the present invention pertains generally to the operating system and user-input or user-interface system of a mobile computing device.

### BACKGROUND OF THE INVENTION

Stereoscopic 3D display (hereinafter, the “S3DD”) pertains to using a 2D display device, such as a computer monitor or a TV screen, to present two offset images that are displayed separately thereon such that each one of the two offset images can only be seen by one of a viewer's two eyes. As for the viewer, both of these offset images are combined in the viewer's brain to give the perception of 3-D depth. One of the most popular applications of S3DD in the marketplace is 3D movies. But when it comes to providing a user with interactive 3D experience, the prior art is only limited to having the images displayed on a small display device, so as to strictly limit the user's viewing angle in order to provide the desired 3D effect. Thus, the prior art is not suitable for providing a user with high-quality interactive 3D experience, such as a 3D computer game on a large display, or for 3D ecommerce. With respect to 3D ecommerce, it is most effective for those big-ticket items, such as automobiles, high-end appliances, and luxury furniture, etc. Without having a high-quality interactive 3D image displayed to the user on a large screen, the user will usually be reluctant to make the purchase of these big-ticket items online without seeing the “real thing”. On the other hand, if a large and high-quality interactive 3D images of these luxury goods can be shown to the user such that the user is willing to make the purchase online without seeing the “real thing”, it will be most profitable for the online merchant (especially for sales of new automobiles, because the large-inventory issue of the traditional auto dealers can be completely resolved). With respect to 3D computer games, providing it on a large display with high-quality interactive 3D image will simply give the user much more fun, which is important since user entertainment is its sole purpose. Thus, it is highly desirable for the technology of providing large and high-quality interactive 3D images in the market place.

The second part of the present inventions pertains to mobile computing devices and the related technologies in general. With respect thereto, the current status of the market place is as follows. The overall advancement of the micro-electronics technologies and of the related manufacturing processes make it possible to provide a small handheld mobile computing device with substantial amount of computing power and memory that require a sophisticated operating system (the “OS”) comparable to that of a traditional computer. And hence the value or competition advantage of a mobile computing device is largely dependent on its multimedia entertainment features. However, the prior art mobile computing devices are not suitable for a very important category of multimedia entertainment, i.e., high-quality or sophisticated computer games. This is because, most of the high-end computer games available in the marketplace requires the gaming device to have sophisticated user input means for letting the user interact with the game, whereas existing touch-screen mobile computing device in the market do not provide any such sophisticated game-interaction input means because the front panel of any of the devices is entirely comprised of the touch screen.

The very basic functionalities of a sophisticated gaming device shall include the user-input means for having an avatar in the game to move to the left, right, front, and back, for making the aviator look up and down, and for 360-degree rotation of the views of the avatar, etc. These avatar-control functionalities are usually realized through one or two analog sticks/nubs (or the like). Since the acceptable thinness of a tough-based mobile device, such as the smart phone or tablet computer, is usually about 1 cm or less, its impractical to install a reliable analog stick/nub. Alternatively, said avatar-control functionalities may also be realized by using physical press buttons, which are traditionally installed on the front panel of the gaming device, and are designed to be operated by the user's two thumbs. But such an arrangement will require at least eight physical buttons, which will occupy about 3-4 inches of the device's front-panel space. However, even a large mobile computing device such as a tablet computer usually only has a front panel width of less than 10 inches. One solution is to use the touch screen of a tablet to simulate these physical buttons, which will substantially reduce the display area of the device both in the horizontal and in vertical direction of the screen. It is understood that, most users prefer to have wide-screen (or landscape) display, i.e., the aspect ratio of the display area of the game is the same or similar to that of a wide screen, while playing a computer game.

Another drawback of the prior art touch-screen mobile computing device pertains to user-input means. Usually, a touch mobile device's user input is mainly realized through various forms of touch gestures performed on its touch screen. But the prior art mobile computing devices do not provide sufficient touch gestures.

### SUMMARY OF THE INVENTION

The method of the present invention shall overcome the foregoing drawbacks of the prior art. Similar to the conventional digital S3DD model, the digital S3DD model of the present invention is also a dual-model system (or “DMS”), comprising a primary 3D model and a secondary 3D model. For the purpose of rendering S3DD effect, the secondary 3D model is slightly different from the primary one in order to reflect the tiny angular observation differences between the left and right eyes of the viewer when the two eyes are looking at the same physical object. A key part of the present invention is to precisely calculate and control said slight difference between the primary and the secondary models of the S3DD DMS. The primary digital 3D model may be constructed with data obtained from a 3D scanner, in which case the S3DD model is provided for representing a real-world physical object. The primary digital 3D model may also be entirely artificially created, such as being entirely created by a computer software application, in which case the S3DD DMS is provided for representing a either a real-world object or an artificial object.

According to the present invention, the secondary digital 3D model of the S3DD DMS is created or derived by modifying a copy of the primary 3D model. The construction of the secondary 3D model maybe independent of the construction of the primary 3D model. When the object represented by the S3DD DMS is relatively small, the secondary 3D model is obtained by adjusting the position and angular orientation of said copy of said primary 3D model. Said adjustment of the position of said copy of said primary 3D model is done in horizontal direction of the display such that there is a displacement in the horizontal direction between the primary and the secondary 3D models (hereinafter, such a displacement is called the Dual-Model Displacement, or the “DMD”). Said adjustment of the angular orientation of the copy of said primary 3D model is, hereinafter, called Dual-Model Angular Shifting, or “DMAS”. When a viewer's two eyes are both looking at a (small) actual physical object represented by said S3DD DMS, there is an observation angle difference (or “OAD”) between the two eyes. The OAD is directly related to the observation distance (or “OD”) between the viewer and the actual physical object. According to the present invention, the amount of said DMAS shall be made equal to said OAD. Assuming that the physical object (or the “object image”) represented by the S3DD DMS is located at a 3D position behind the display screen, then the values of the DMD and DMAS are dependent on the virtual 3D position of the object image behind the display screen relative to the physical 3D positions of the viewer's two eyes.

A geometry analysis based on the foregoing will show that: (a) when the (small) object is situated close to the viewer, the value of the corresponding S3DD DMD is relatively small, whereas the value of the corresponding S3DD DMAS is relatively large; and (b) when the (small) object is far from the viewer, the corresponding S3DD DMD is relatively large, whereas the value of the corresponding S3DD DMAS is relatively small. When the size of the object represented by the S3DD DMS is relatively large, it is necessary to divide the corresponding primary 3D model and the copy into a plurality of small sub-models or elements, and treat each one of these sub-models or elements as an independent 3D model; then the foregoing method of calculating the values of the DMD and DMAS will be applied on each and every one of these small sub-models, and the foregoing procedures of displacement and angular adjustment or shifting will be performed on each one of these sub-models accordingly.

With respect to the aforementioned second part of the present invention, the foregoing drawbacks of the prior art can be solved by having a plurality of game-interaction physical buttons (or the like) installed at the back panel (instead of the front panel) of the mobile device, and they shall be designed to be operated by the user's index or middle fingers (instead of by the thumbs). In fact the method of assigning game-interaction functionalities to different physical buttons is not novel, except that in the prior art, these avatar-control buttons are always installed at the front-panel of the gaming device, and are always designed to be operated by the user's two thumbs. An alternative solution to said drawbacks of the prior art is to provide the mobile device with detachable analog nubs (or analog sticks) at the front surface of the device. Since the analog nubs (or sticks) can be detached from the device, they will not increase the thickness of the device.

The third part of the present invention pertains to providing a mobile computing device with novel GUI (graphic user interface) means, which will make multi-tasking on a small touch screen device much easier, and which will also substantially enrich the functionality of the touch gestures.

### BRIEF DESCRIPTION OF THE DRAWINGS

FIG. 1 is a schematic illustration of a prior art or conventional single model (or 2D) display presented to a viewer.

FIG. 2 is a schematic representation of a viewer experience of looking at a real physical object that is to be simulated by the display arrangement of FIG. 1.

FIG. 3 is a schematic illustration of the general concept of using a 2D display device to present S3DD models to a viewer.

FIG. 4 is a schematic representation of a viewer experience of looking at a real physical object that is to be simulated by the display arrangement of FIG. 3.

FIGS. 5 and 6 are for illustrating the method of accurately obtaining the values of DMD and DMAS for the purpose of constructing the S3DD DMS according to the present invention. FIG. 6 is an enlarged view of the top portion of FIG. 5.

FIG. 7 is an alternative of FIG. 5 for depicting an alternative way of arranging the secondary 3D model, which is obtained through modifying a copy of the primary 3D model.

FIGS. 8 and 9 are for illustrating the method of obtaining the secondary 3D model from the primary 3D model when the physical object represented thereby is relatively large.

FIGS. 10-15 are for demonstrating the methods of providing a mobile device with sophisticated game-interaction user-input means; FIGS. 10 and 12 are illustrations of exemplary arrangements of game-interaction buttons on the back-panel of a mobile device; FIG. 11 illustrate the front screen display associated with FIGS. 10 and 12; FIGS. 13-15 are for depicting the method of providing detachable analog nubs at the front panel of a mobile device,

FIGS. 16-31 are schematic representations of various views of the front display screen of a mobile computing device for the purpose of demonstrating novel GUI methods and touch gestures of the present invention.

FIGS. 32-34 are side or cross-sectional views of a mobile computing device for the purpose of demonstrating a novel method of providing a pneumatically-cushioned keyboard at the back panel of the mobile computing device according to the present invention.

FIGS. 35 and 36 are for demonstrating the method of improving web search engine according to the present invention. FIG. 35 is a schematic representation of a conventional web search engine homepage; FIG. 36 is a schematic representation of an improved web search engine homepage according to the present invention.

FIG. 37 is a schematic illustration of the basic principal of a phone/watch device according to one aspect of the present invention.

FIGS. 38 and 39 are side views of the top portion of an exemplary engagement mechanism of the phone/watch device of FIG. 37.

FIG. 40 is a top view of the bottom/base portion of the exemplary phone/watch device associated with FIGS. 38 and 39.

FIG. 41 is an enlarged view of the back surface of an exemplary phone/watch device of FIG. 37.

FIG. 42 is an enlarged view of the front surface of an exemplary phone/watch device of FIG. 37.

FIG. 43 is a block diagram illustrating the basic concept of the Cloud-Based Operating System of the present invention.

FIG. 44 is a flow chart of an exemplary process of setting up a Cloud-Based OS account according to the present invention.

FIGS. 45 and 46 are exemplary live home pages associated with the Cloud-Based OS concept of the present invention.

FIG. 47 is an exemplary service provider's information subscription page associated with the Cloud-Based OS concept of the present invention.

FIGS. 48 and 49 are two Cloud-Based OS applications associated with the information subscription operation of FIG. 47.

FIG. 50 is another front view of the phone/watch device of FIG. 37 for illustrating a barcode creation/display client app according to the present invention, which is also provided for demonstrating the concept of providing immediate cloud-based electronic purchasing receipt on a user's mobile device according to another aspect of the present invention.

### DETAILED DESCRIPTION OF THE INVENTION

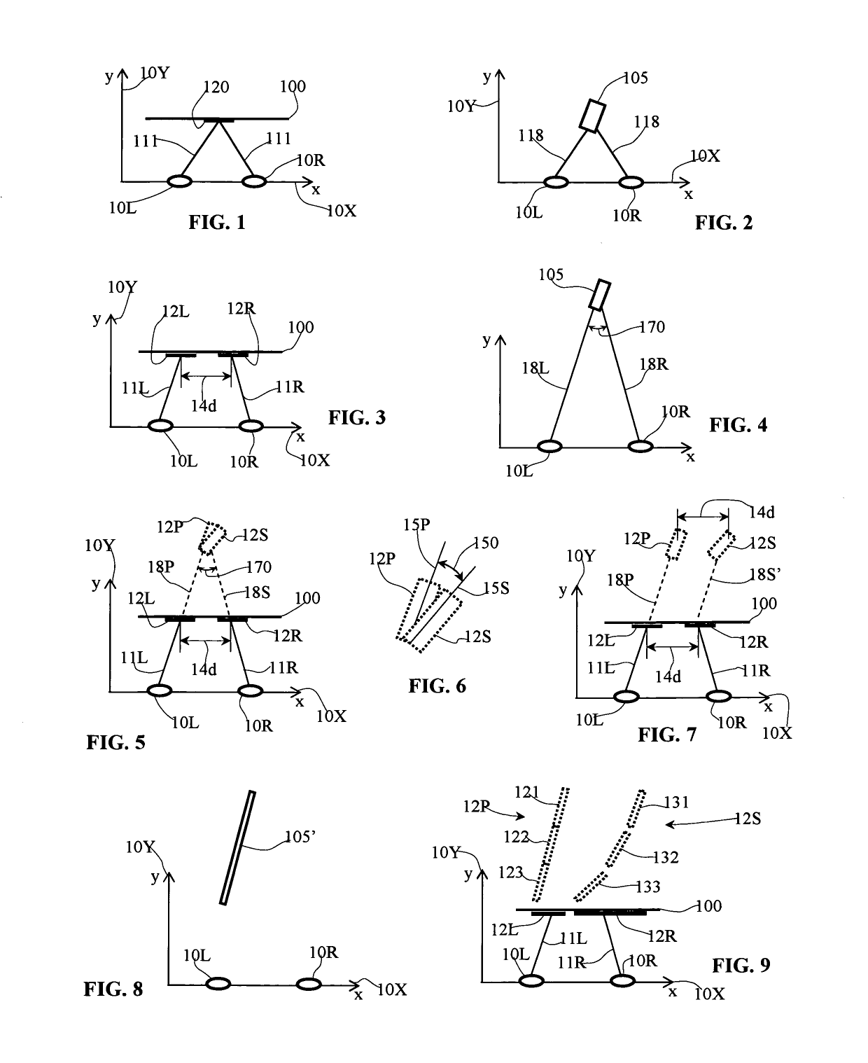

Referring to FIGS. 1-36, there are shown new and novel methods and systems for constructing a digital S3DD model, novel mobile device game-interaction user input means, and novel GUI methods for touch-screen mobile device according to the present inventions. While the present inventions are susceptible to embodiments in various forms, there is provided detailed description of the presently preferred embodiments, with the understanding that the present disclosure is to be regarded as exemplifications, and does not limit the invention to the specific embodiments illustrated or described. In many instances, detailed descriptions of well-known elements, electronic circuitry, or computer or network components, and of detailed methods of well-known geometric calculations are omitted so as to not obscure the depiction of the invention with unnecessary details.

It shall also be understood that, in cases where the best mode is not particularly pointed out herein, the preferred embodiment described shall be regarded as the best mode; and that, in cases where best mode is alleged, it shall not be construed as having any bearing on or as contemplating the results of future research and development. The industrial exploitation of the present invention, such as the ways of making, using, and of the sales of the related software and hardware products, shall be obvious in view of the following detailed description.

FIG. 1 illustrates a simplified traditional 2D image display scenario, in which a 2D image 120 is displayed on a 2-D display screen 100, and is viewed by a viewer's two eyes 10L and 10R. All the light 111 from the 2D image 120 can be seen by both the two eyes 10L and 1 OR of the viewer. It is understood that, in FIGS. 1-9 in connection with the detailed descriptions of stereoscopic 3D display model of the present invention, (a) there is provided a x-direction line 10X passing through the centers of the two eyes 10R and 10L of the viewer, which is parallel to the horizontal direction of the 2-D display screen 100; (b) there is also provided a y-direction line 10Y that is perpendicular to the x-direction line 10X and is also perpendicular to the surface of the display screen 100; and in addition, (c) light paths represented by solid lines (such as the light paths 111 in FIG. 1, 118 in FIG. 2, 18L and 18R in FIG. 4, and the light paths 11L and 11R in FIGS. 3, 5, 7, and 9) means the existence of actual physics of light paths; and (d) any light path represented by dashed line (such as the light paths 18P and 18S/18S′ in FIGS. 5 and 7) means its virtual light path.

It is also understood that, the y-direction 10Y is the direction of 3D “depth”, and hence the 3D effect disclosed herein pertains to information associated with changes in the y-direction 10Y. It is also understood that, the physics of the Stereoscopic 3D Display (or the “S3DD”) effect experienced by a viewer is a result of the position difference in the x direction between the left eye 10L and right eye 10R of the viewer. Thus conceptually, any change in the z direction, which is perpendicular to the x-direction 10X and y-direction 10Y, is not relevant to the S3DD effect. Therefore, in all these drawings, the 2D plane defined by the x-y axes, or 10X-10Y, is employed for representing the 3D physics. And consequently, (i) a 2D image, such as the image 120 on the screen 100 in FIG. 1, is represented by a 1-D bar 120; (ii) a 3D physical object (such as the object 105 of FIG. 2) or a virtual 3D model (such the 3D Model 12P in FIGS. 5-7) is represented by a 2D rectangle, and (iii) any position in the x-y plane is called a “3D position”. Ignoring any variation in the z direction makes it much easier to illustrate and describe the S3DD Dual Model System (or the “DMS”) of the present invention.

In FIG. 1, the display of the 2D image 120 on the screen 100, which is to be viewed by the viewer's two eyes 10L/10R, shall simulate a viewer's experience of looking at a real physical object 105 of FIG. 2, in which the light lines 118 go from the physical object 105 to the viewer's two eyes 10R and 10L. Evidently, the image 120 in FIG. 1 is a 2D image of the real object 105 in FIG. 2. The distance between the physical object 105 and the x-direction line 10X passing through the two eyes 10L/10R in FIG. 2 shall be the same as the distance between the screen 100 and the two eyes 10L/10R of FIG. 1. This is because, the traditional 2D image 120 does not provide any depth-related information (i.e., change y-direction).

The fundamental concept of S3DD is illustrated in FIG. 3, in which two separate 2D images 12L and 12R of a real physical object 105 are presented on the display screen 100. The 2D image 12L is only to be seen by the left eye 10L, as indicated by the solid light path 11L, and the 2D image 12R is only to be seen by the right eye 10R, as indicated by the solid light path 11R; And there is a displacement 14d in the x-direction 10X between the two images 12L and 12R on the screen 100. Hereinafter, such a displacement vector 14d is called Dual-Model Displacement (or the “DMD”).

The reason for having two separate 2D images, i.e., 12L and 12R, of the same physical object 105 on the display screen 100 is, the S3DD is a Dual Model System (or “DMS”). Said DMS comprises two digital 3D models: including a Primary Model 12P and a Secondary Model 12S (See FIGS. 5-7): the 2D image 12L is the 2D display of the Primary Model 12P on the screen 100, and the 2D image 12R is the 2D display of the Secondary Model 12S on the screen 100. The Primary Model 12P is usually predetermined. For examples, (i) the Primary Model 12P may be obtained using a 3D scanner to scan the real physical object 105, and it is usually made identical to the real physical object 105; or (ii) it may be entirely or partially artificially (or digitally) created using a graphic-design software program or the like. The present disclosure is not related to any method of creating the Primary Model 12P. Instead, the following discussion pertains to methods of accurately deriving the Secondary Model 12S from the Primary Model 12P such that the S3DD DMS can provide a viewer experience that is very close to (or sometimes even better than) viewing a real physical object regardless of the size of the display screen and of how close or how far away the object is situated from the viewer.

Again, the S3DD of FIG. 3 is provided for simulating a viewer experience of viewing a real physical object 105, which is shown in FIG. 4, in which the two light paths 18L/18R go from the physical object into the viewers' two eyes 10L/10R. According to the present invention, the Secondary Model 12S shall be obtained by modifying a copy of the Primary Model 12P by accurately calculating the difference between them. In particular, the difference between the Primary Model 12P and the Secondary Model 12S is their orientation in the x-y plane. FIG. 6 is an enlarged view of the Primary and Secondary Model 12P and 12S shown in FIG. 5. In FIG. 6, (i) the direction line 15P is a hypothetical symmetry line of the Primary Model 12P; (ii) the direction line 15S is the corresponding hypothetical symmetry line of the Secondary Model 12S, and (iii) there is an angle 150 between the two direction line 15P and 15S. Thus, the Secondary Model 12S shall be obtained by rotating a copy of the Primary Model 12P in the x-y plane 10X-10Y (i.e., the rotation axis is perpendicular to the x-y plane 10X-10Y) by an angular amount 150. Hereinafter, such an angular amount 150 between the Primary Model 12P and the Secondary Model 12S is defined as the Dual-Model Angular Shifting (or the “DMAS”). In addition, as described above, there is a displacement or DMD 14d, between the 2D display 12L of the Primary Model 12P and the 2D display 12R of the Secondary Model 12S, and the value of the DMD 14d also needs to be accurately obtained.

In order to accurately obtain the values of DMD 14d and DMAS 150, it may be assumed that the Primary Model 12P is situated behind the screen 100 (see FIG. 5), and the 3D position of the Primary Model 12P (situated behind the screen 100) relative to the positions of the two eyes 10L and 10R is identical to the 3D position of the real physical object 105 relative to the positions of the two eyes 10L and 10R in FIG. 4. Hereinafter, (a) the triangle formed by the position of the real object 105 and the positions of the two eyes 10R and 10L (FIG. 4) is defined as the Two-Eyes Observation Triangle (or the “TEO” TRIANGLE); (b) the triangle defined by the 3D position of the Primary Model 12P behind the screen and the positions of the two eyes 10R and 10L (FIG. 5) is defined as the Two-Eyes Virtual Observation Triangle (or the “TEVOT”); and (c) the top angle 170 of the TEO TRIANGLE (FIG. 4) is defined as the aforementioned Observation Angle Difference (or “OAD”) between the two eyes 10L/10R. The simple geometry of FIG. 5 shows that, the value of DMD 14d is dependent on the position of the screen 100 and the shape of the TEVOT. According to the present invention, in order obtain the values of DMD 14d and DMAS 150, (i) the TEVOT of FIG. 5 shall be made identical to the TEO TRIANGLE of FIG. 4. (hereinafter, they are both called TEO TRIANGLE), and (ii) the DMAS 150 shall be the same as the OAD 170 of the TEO TRIANGLE.

The reason behind the foregoing method of obtaining the values of DMAS 150 and DMD 14d is as follow: it can be imagined that in FIG. 5, the viewer's two eyes are looking at a “Virtual/Real” physical object 105 situated at the 3D position of the Primary Model 12P behind the screen 100. But the light lines do not go directly from the “Virtual/Real” object 105 into the two eyes 10L/10R. Instead, the “Virtual/Real” object 105 will have two copies 12P and 12S: (i) the 1st copy 12P flies off from the body of the “Virtual/Real” object 105 onto the screen 100 (as indicated by the virtual light path 18P), becoming the 2D image 12L thereon; then it flies off from the screen 100 and into the left eye 10L (as indicated by the actual light path 11L); and (ii) the 2nd copy 12S flies off from the body of the “Virtual/Real” object 105 onto the screen 100 (as indicated by the virtual light path 18S), becoming the 2D image 12R thereon; then it flies off from the screen 100 and into the right eye 10R (as indicated by the actual light path 11R). Note that, the Primary Model 12P shall be made identical to the real physical object 105.

In summary, the 3D position of an object to be simulated by S3DD is usually know. So the corresponding TEO TRIANGLE can be defined with respect to such an object, from which the OAD 170 can be obtained. The value of DMAS 150 is made equal to that of the OAD 170; so the Secondary Model 12S can be obtained by rotating a copy of the Primary Model 12P by the amount of OAD 170 in the x-y plane. Since the distance between the display screen 100 and the viewer's eyes 10R/10L is usually known, when TEO TRIANGLE is defined, the value of DMD 14d can be obtained through simple geometry analysis.

It is understood that, the method of FIG. 5 assumes that the virtual 3D positions of the Primary Model 12P and of the Secondary Model 12S are the same; And the operation of DMD is performed at the final step of displaying. Alternatively, since the light path 18S is a virtual path, it can be assumed that there is a DMD in x-direction 10X by the amount of 14d between the Primary Model 12P and the Secondary Model 12S, such that the virtual light path 18S′ from the Secondary Model 12S to its 2D image 12R on the screen is parallel to the virtual light path 18P from the Primary Model 12P to its 2D image 12L on the screen 100, as is shown in FIG. 7. The benefit of the method of FIG. 7 is, its more convenient in graphical illustration of a more complex object model (see below).

It is understood that the absolute values of the DMD 14d and DMAS 150 to be obtained by these methods for each individual object within the S3DD DMS is not so important. In fact if there is only one 3D object image to be presented to a viewer, the absolute values of the associated DMD 14d and DMAS 150 can be even adjusted. However, when the S3DD DMS includes more than one 3D objects, the relative changes in the values of DMD 14d and DMAS 150 between different objects needs to be accurately obtained, which can only be done by using the foregoing geometry methods of the present invention. In fact it is the accuracy of the relative changes in the values of DMD 14d and DMAS 150 between different objects that is critical in presenting large and high-quality 3D images to a viewer. In the foregoing geometry analysis, it is assumed that the viewer is situated in front of the center of the display screen 100. Once the accurate values of the DMD 14d and DMAS 150 for every 3D object are so obtained, the high-quality 3D images can be displayed to the viewer even when the viewer is not positioned near the center of the screen. This is because of the accuracy of the relative changes in the values of DMD 14d and DMAS 150 between different objects.

In the foregoing analysis, it is assumed that, the size of the object 105 to be simulated on the screen 100 is small. If the size of such an object to be simulated on the screen 100 is large, then the TEO TRIANGLE shall be different for different part of such a large object. So the Primary Model 12P of a large object shall be divided into a plurality of small sub-models in order to obtain the Secondary Model 12S. FIG. 8 illustrates a viewer experience of looking at a relatively long real physical object 105′ with her two eyes 10L and 10R. Such a viewer experience of FIG. 8 is to be simulated by presenting, on the display screen 100, a first 2D image 12L and a second 2D image 12R, as is shown in FIG. 9. Similar to FIGS. 5 and 7, the 2D image 12L is the 2D display of a Primary 3D Model 12P on the screen 100, and the 2D image 12R is the 2D display of a Secondary 3D Model 12S on the screen 100. In order to obtain the Secondary Model 12S from the Primary Model 12P, the Primary Model 12P and its copy is divided into three sub-models, including the sub-models 121, 122, and 123. Then each one of these 3 sub-models 121, 122, and 123 is treated as a Primary Model independent of other sub-models. So the Secondary Sub-model 133 corresponding to the Primary Sub-model 123 is obtained by (i) rotating a copy of the sub-model 123 in the x-y plane by the amount of DMAS 150, which is made equal to the value of the corresponding of the OAD 170, and (ii) shifting said copy of the sub-model 123 in the x-direction 10X by the amount of DMD 14d. The values of such OAD 170 and the DMD 14d is determined by (i) the position of the screen 100 and (ii) the TEO TRIANGLE defined by the positions of the two eyes 10R and 10L and the 3D position of the center of the sub-model 123. Similarly, the TEO TRIANGLES associated with the sub-models 121 and 122 are defined by the center positions of the sub-models 121 and 122, respectively, together with the positions of the two eyes 10L/10R, from which the values of the corresponding DMD 14d and OAD 170 can be obtained.

It can be seen from the geometry analysis of FIG. 5 that, (i) when a primary model or sub-model is close to the screen 100, the value of the corresponding DMD 14d is relatively small, and the value of the corresponding OAD 170 is relatively large; and (ii) when a primary model or sub-model moves away from the screen 100, the value of the corresponding DMD 14d will become larger, and the value of the corresponding OAD 170 will become smaller. So in FIG. 9, the resultant Secondary Model 12S, comprising the sub-models 131, 132, and 133, is a curved and non-smooth model. It is understood that, (i) the Primary Model 12P shall be made identical to the real physical object 105′, as described above; and (ii) even though the geometric form of the Primary Model 12P and the real physical object 105′ is straight, continuous, and smooth, the Secondary Model 12S can be a curved and none-smooth 3D Model, as is shown in FIG. 9. Such a method of treating large or long object is important when trying to display a object that is close to the viewer's eyes with accurate and realistic S3DD effect, which is important in 3D ecommerce.

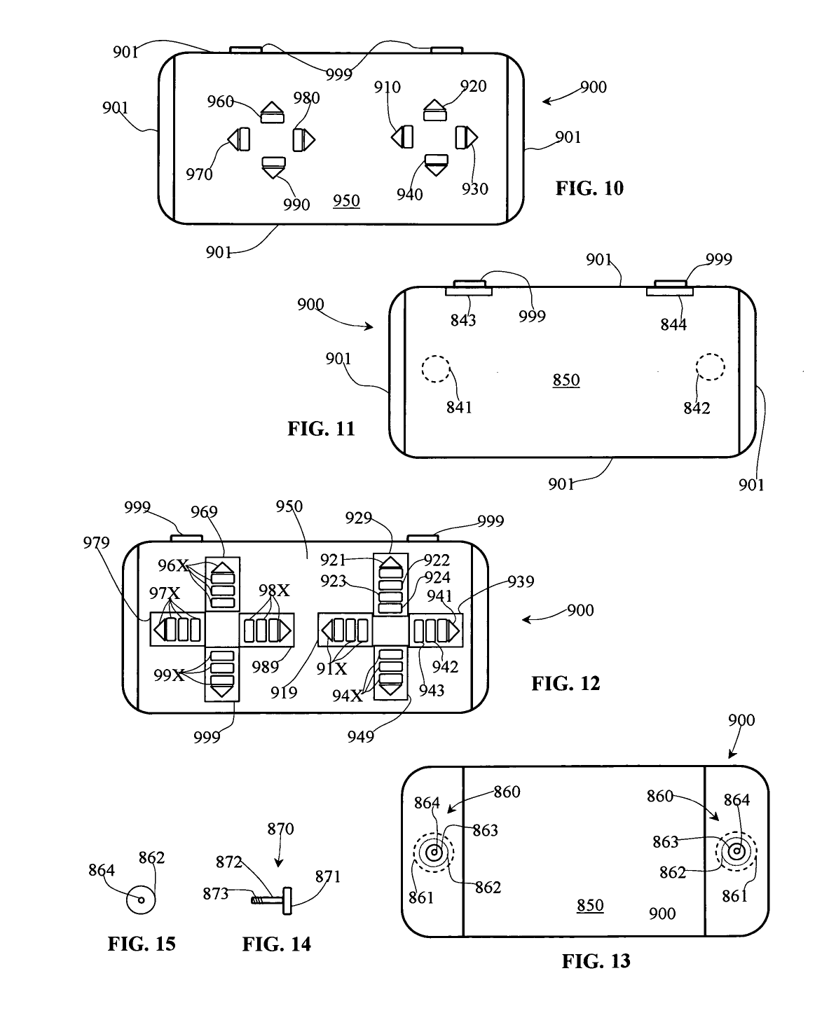

The second part of the present invention pertains to providing a mobile device, such as a smart phone or a tablet computer, with user-input means for allowing a user to play hi-end computer games without increasing the physical thickness of the device. One method of accomplishing this is to provide a plurality avatar-control buttons at the back panel 950 of the device for providing 8-dimensional avatar-movement control. These 8-dimension avatar control buttons situated at the back cover of the device are to be operated by the two index (or middle) fingers of the user, instead of by the thumbs. An alternative method is to provide the mobile device with detachable analog nubs (or analog sticks) at the front surface 850 of the mobile device. Since the analog nubs (or sticks) can be detached from the device, they will not increase the physical thickness of the device. The details of these game-interaction user-input means are described below in conjunction with FIGS. 10-15.

FIG. 10 is a schematic representation of the back panel 950 of a mobile device 900. As mentioned above, most of the high-end computer games with high-resolution graphic displays involve control of an avatar (or the like). Such avatar control can be regarded as comprising eight dimensions, including (1-4) the avatar moving forward, backward, to the left, and to the right; (5-6) the avatar looking up and down; and (7-8) the avatar rotating or spinning towards left and right. In FIG. 10, these 8-dimension avatar controls are provided by eight physical buttons at the back panels 950 of the mobile device 900. In particular, (1) the button 920 is for moving the avatar forward; (2) the button 940 is for moving the avatar backward, (3) the button 910 is for moving the avatar to the right, (4) the button 930 is for moving the avatar to the left; (5) the button 960 is for making the avatar (or the game “camera”) look upward, (6) the button 990 is for making the avatar (or the game “camera”) look downward, (7) the button 980 is for making the avatar (or the game “camera”) rotate toward its left, and (8) the button 970 is for making the avatar (or the game “camera”) rotate toward its right. The buttons 910, 920, 930, and 940 are to be operated by the index or middle finger of the user's left hand; And the buttons 960, 970, 980, and 990 are to be operated by the index or middle finger of the user's right hand. In case where the user wants the avatar to move towards a front-left direction, she will just need to press the buttons 920 and 980 together at the same time. So these eight buttons on the back panel 950 of the mobile device 900 can provide full control of an avatar (or the like) in a high-end computer game. Certainly, the game designers can assign these buttons to different avatar-control functions. For example, when the avatar in the game is a helicopter, the buttons 960 and 990 can be assigned to be used for ascending and descending respectively, etc.

Referring now to FIG. 11, usually the front surface of the mobile device 900 includes a touch-sensitive screen 850 for displaying the game contents. In addition to displaying the primary display contents of the computer game, the front screen 850 can also provide one or more virtual or simulated buttons 841 and 842 near its two sides. These simulated virtual buttons 841 and 842 are to be operated by the user's two thumbs for causing the avatar to perform a main action. Most of the computer games provide the avatar with at least one (or more) form of main action. Examples of such avatar main actions are: pulling the trigger of a weapon, kicking the ball, and catching the ball, etc. In order to provide more avatar-control buttons, the side frame 901 of the mobile device 900 can also be made touch sensitive. In this way, the front display screen 850 can provide button indicators at its edges for indicating which segment of the touch-sensitive side frame 901 is to be used for a particular form of avatar control function. In the example of FIG. 11, (i) the indicator 843 displayed at the top edge of the screen 850 means that, if the portion of the touch-sensitive side frame 901 corresponding to the indicator 843 is touched by the user's left index finger, it will cause the avatar in the game to perform a specific action (such as jumping); and (ii) the indicator 844 displayed at the top edge of the screen 850 means that, if that portion of the touch-sensitive side frame 901 corresponding to the indicator 844 is touched by the user's right index finger, it will cause the avatar in the game to perform another action (such as changing weapon). Ideally, the computer game program shall allow the user to adjust the positions of the virtual buttons 841 and 842 and the positions of the indicators 843 and 844.

Moreover, it is understood that, a physical button can give the user a comfortable feeling of “pressing a button” during the gameplay; And such a type of comfortable feeling during interaction with the game cannot be replaced by a simulated button on the touch-sensitive screen 850. For the same reason, it is preferred that, physical buttons 999 are provided at the side of the device 900 for implementing the functions association with the icons 843 and 844, respectively (FIGS. 10-12).

In the example of FIG. 10, the aforementioned 8-dimension avatar controls are provided by eight buttons, with each one of these eight dimensions being controlled by one button. A disadvantage of such an arrangement is, it is not quite suitable for the type of games that include substantial amount of competition or sports elements or the like. Examples of such competition/sports elements in a game are: the user trying to (a) make the avatar quickly move to the left at the highest possible speed in order to hit a tennis ball, (b) make the avatar take a small step to the right in order to throw or kick a ball to the right teammate, (c) have the avatar kicking the soccer ball at an finite upward direction in order to pass through the defense players, and (d) have avatar quickly turn 90 degree to the left in order to shoot the bad guy, etc. When a game include substantial amount of such type of competition or sports elements, usually double-clicking a button is the maximum the user wants to do, meaning that triple clicking (or more) or holding the button would be deemed too slow or non-intuitive, and would thus substantially reduce the entertainment value of the game. One way of remedying such a drawback is to provide many more avatar-control buttons at the back panel 950 of the mobile device 900. Since the back panel 950 cannot be seen by the user during the game play, it is necessary to carefully arrange the positions of these avatar-control buttons to make it intuitive for operations by the user's index or middle fingers.

FIG. 12 shows an improved arrangement of 8-dimension avatar control buttons. In FIG. 12, (1) the single button 920 in FIG. 10 is replaced by four vertically aligned buttons 921, 922, 923, and 924, which are provided for moving the avatar forward; (2) the single button 910 in FIG. 10 is replaced by three horizontally aligned buttons 91X, which are provided for moving the avatar to the right; (3) the single button 930 in FIG. 10 is replaced by three horizontally aligned buttons 941, 942, and 943, which are provided for moving the avatar to the left, (4) the single button 940 in FIG. 10 is replaced by three vertically aligned buttons 94X, for moving the avatar backward, (5) the single button 960 in FIG. 10 is replaced by four vertically aligned buttons 96X, for making the avatar look upward; (6) the single button 970 in FIG. 10 is replaced by four horizontally aligned buttons 97X, for rotating the avatar to the right; (7) the single button 980 in FIG. 10 is replaced by three horizontally aligned buttons 98X, for rotating the avatar to the left, and (8) the single button 990 in FIG. 10 is replaced by three vertically aligned buttons 99X, for making the avatar look downward.

The arrangement of the 8-dimension avatar control buttons of FIG. 12 shall give the game designers much more flexibility in providing rich game-interaction features. For examples, the game can be designed to including the following features: (i) if the user wants to move avatar forward very slowly, she can single click the button 924; (ii) if the user want to move avatar forward very fast, she can double click the button 921, and (iii) if the user want to move the avatar quickly to the left, she can click the button 941, etc. Evidently, the arrangement of the 8-dimension avatar control buttons of FIG. 12 allows the game designer to include substantial amount of aforementioned competition or sports elements in the game.

In FIG. 12, each group of the avatar control buttons are surrounded by a border: (1) the four forward buttons 921, 922, 923, and 924 are surrounded by a border 929; (2) the three backward buttons 94X are surrounded by a border 949; (3) the three left-moving buttons 941, 942, and 943 are surrounded by a border 939; (4) the three right-moving button 91X are surrounded by a border 919; (5) the four upward-looking buttons 96X are surrounded by a border 969; (6) the three downward-looking buttons 99X are surrounded by a border 999; (7) the three right-rotation buttons 97X are surrounded by a border 979; and (8) the three left-rotation buttons 98X are surrounded by a border 989. The purpose of providing these button borders 919, 929, 939, 949, 969, 979, 989, and 999 is to let the user rest her operating fingers at the best positions when not operating the avatar-control buttons. When the user “rests” one of her fingers on these borders, she can easily feel where said finger is located relative to the 8-dimension avatar control buttons. Again, the user cannot see the back panel 950 during the game play. For example, if the user wants to move the avatar to the left, and the speed of such left moving shall be dependent on the direction of a incoming tennis ball, she can rest her left index finger on the border 939 while waiting for said incoming tennis ball, etc. Alternatively, those individual buttons within a border can be replace by a piece of continuous touch pad or the like. For examples, (i) the four forward buttons 921, 922, 923, and 924 within the border 929 can be replaced by a piece of continuous touch pad within the border 929; and (ii) the three backward buttons 94X within the border 949 can also be replaced by a piece of continuous touch pad, etc.

Alternatively, the 8-dimension avatar control buttons on the back panel 950 of the mobile device 900 described above in association with FIGS. 10 and 12 can be replaced by a pair of detachable analog sticks (or analog nubs) 860 at the front panel 850 of the device 900. Reference is now made to FIGS. 13-15. The mechanism of said detachable analog nubs 860 can be simplified as comprising two key components, including (i) a top portion 870 (FIG. 14), and (ii) a bottom or base portion 862 (FIG. 15). The base 862 includes internal thread at its center 864. The top portion 870 includes (a) a cap portion 871, which is to be operated by the user's thumb, and (b) a stick portion 872. The bottom end of the stick 872 comprises external thread 873, which is to be used for engaging with the internal thread 864 of the base 862. Evidently, other types of mechanical engagement means between the top portion 870 and the nub base 862 can also be used. The base 862 is situated within a socket 861 inside the device 900. The socket 861 and the nub base 862 together provide the conventional means of detecting the movement of the stick 870 in response to the operations of the user's thumb. The top surface 850 of the device 900 include a circular opening 863 for facilitating the engagement of the stick 871 with the base 862. Since the top portion 870 of the analog nub 860 can be detached from the device 900, such an arrangement will not require the mobile device 900 to be made thicker.

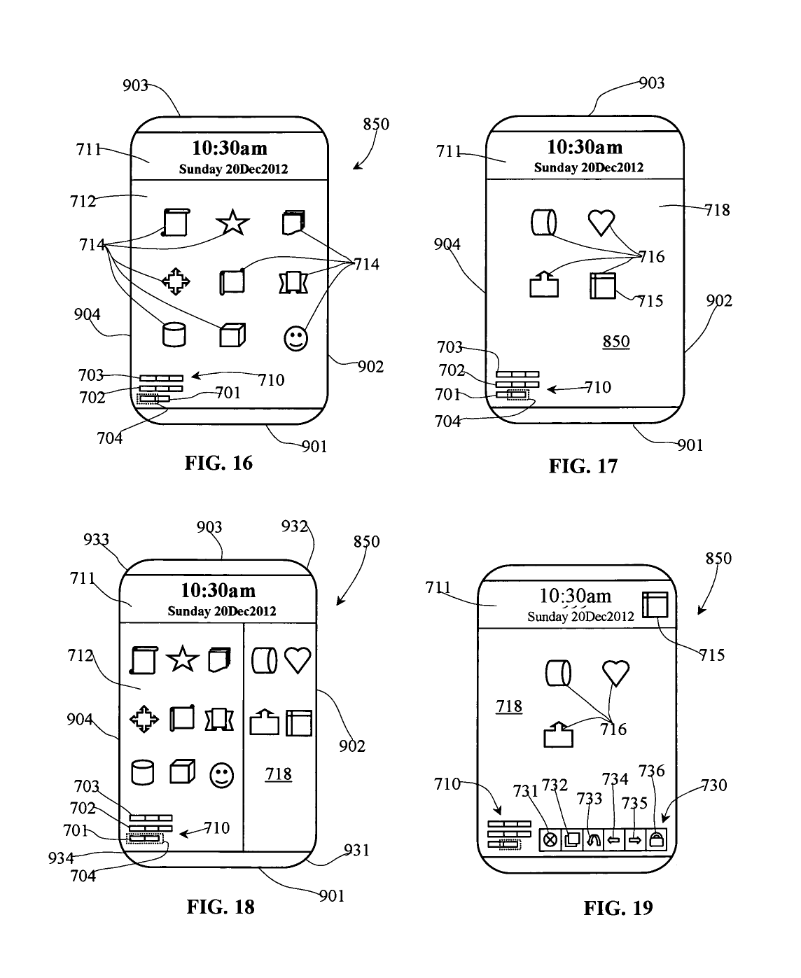

The third part of the present invention pertains to providing a mobile computing device with novel GUI (graphic user interface) means, which will be described in detail below in conjunction with FIGS. 16-31. As it is well known, a mobile computing device usually has a relatively small touch-sensitive screen, and is often not provided with a mouse and keyboard for user input. Instead, hand touch gestures, such as “swipe”, which are to be performed on the device's touch-sensitive screen 850, are the primary user input means of a mobile device. One object of the present invention is to substantially increase the functionalities of the touch gestures. The present invention will also allows a user to easily conduct multitasking and window controls and navigation on a small touch-screen mobile device.

In FIG. 16, the front screen 850 of the device 900 displays a first homepage 712 of the mobile device; And in FIG. 17, the front screen 850 displays a second homepage 718. The first homepage 712 includes a plurality of items 714; And the second homepage 718 also includes a plurality of items 716 and 715. As shown, whenever one of the two homepages 712 and 718 is displayed in portrait orientation, a live-information section 711 is always shown at the top portion of the display 850. The live-information section 711 shall also be used as a temporary docking area for temporarily holding any item, so as to facilitate the operation of moving an item from one folder to another (or the like). For example, in FIG. 19, the item 715 on the second homepage 718 of FIG. 17 has been moved to this temporary docking area, causing the display of the live information 711 to become a little dimmer. Thereafter, when the first homepage 712 is moved back into display, the item 715 shall still be situated at the live-information area 711 such that the item 715 can be moved into a folder within the first homepage 712. According to the present invention, in order to facilitate multitasking on a small-screen mobile device, a Window Navigation Map (or the “WNM”) 710 is always provided at the lower-left corner of the display screen 850.

The main purposes of providing the WNM 710 are: (a) to show to the user how many windows have been opened, (b) to show the position of the current display screen relative to other opened window, so as to (c) facilitating multitasking by making it very easy to switch the display 850 to different windows, and (d) to provide window control and screen-display control functionalities. In the examples of FIGS. 16-17, the WNM 710 comprises three rows of boxes, including rows 701, 702, and 703. The number of rows within the WNM 710 means the number active applications (or programs). So the example of FIG. 16 has are a total of three active applications, which are associated with and indicated by the three rows 701, 702, and 703 respectively. It is preferred that, the first row from the bottom, i.e., the row 701, is always employed for indicating the homepages. In this way, the user will ALWAYS know how to get back to the home page, and how to switch to any of the previous application windows. So there is no need to provide any physical buttons on the device for letting the user get back to the homepage or the like, and the entire front side 850 of the device may only comprise the touch screen, nothing else (which is desirable for a small device such as a smart phone).

The number of small boxes within each row in WNM 710 means number of windows opened for the corresponding application; and these small boxes are sometimes called “window boxes” herein. So in the example of FIGS. 16-17, the homepage application includes two windows: (i) the first window box within the 1^{st} row 701 of the WNM 710 is associated with the first homepage 712 (FIG. 16), and (ii) the second window box within the 1^{st} row 701 of the WNM 710 is associated with the second homepage 718 (FIG. 17). Similarly, the second row 702 includes three window boxes, indicating that there are three windows opened for the corresponding application; and the third row 703 also includes three window boxes, indicating that there are three windows opened for the application associated with the row 703. So the WNM 710 in the example of FIG. 16 shows that, there are three active applications, with a total of eight windows open.

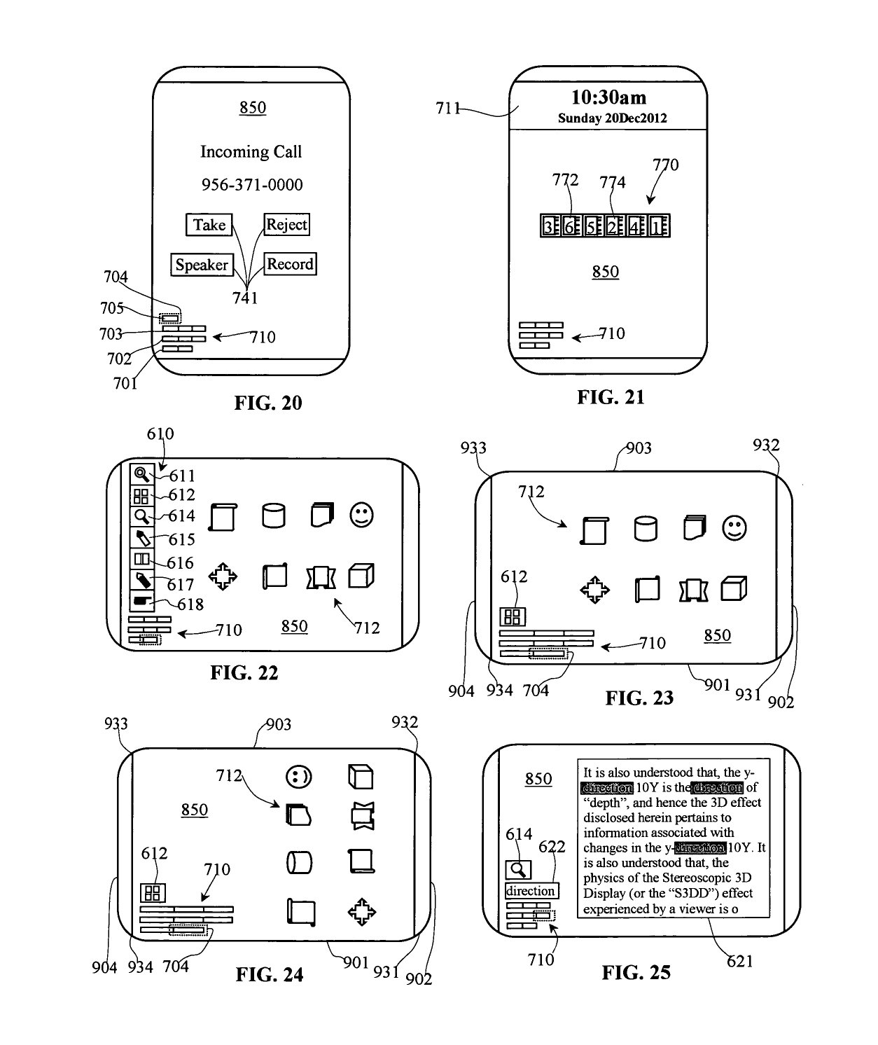

Additionally, the WNM 710 also includes a current-window indicator 704, which is a box with dashed side lines, for indicating which window is currently on display. For examples, (a) in FIG. 16, when the first homepage 712 is displayed, the dashed box 704 is situated at the first window box of the first row 701 on the WNM 710; (b) in FIG. 17, when the second homepage 718 is on display, the dashed box 704 is situated at the second window box of the first row 701 on the WNM 710; and (c) In FIG. 20, when there is an incoming call, the phone application shall be activated; and accordingly, a 4^{th} row 705 comprising one window box is created on the WNM 710, and in the meantime, the current-window indicator 704 is moved to the position 705. As shown, the phone-receiving screen of FIG. 20 includes a plurality of buttons 741 for providing the user with different options. After taking the call, if the user wants to continue the previous task while talking on the phone, she can turn on the speaker phone and swipe the widow of the said previous task back into display with the help of the WNM 710. For example, if the user wants to move back to the first homepage 712 while talking on the phone, she can perform the “Window-Switching” hand gesture in upward direction (see below). As used herein and in the annexed Claims, the term “Window-Switching” means causing a currently displayed window to move (or slide) away from the display and causing a previously hidden window to move (or slide) onto the display position.

According to the present invention, in order to provide more hand-gesture user-interaction means, the side frame enclosing the display screen 850 of the mobile device shall also be made touch sensitive. As it is well known, the conventional swipe gestures, which are to be performed on the top touch-sensitive screen 850 of the device, are usually for interacting with the page content (or the like) displayed within a window (such as page scrolling). Evidently, such an arrangement is intuitive. However, the prior art mobile-device GUI does not provide any intuitive hand touch gesture means (or the like) for window switching. It is unintuitive to employ touch gestures performed on the top touch-sensitive screen 850 to conduct any type of window switching or the like for the obvious reason. According to the present invention, by making the four sides 901, 902, 903, and 904 (FIGS. 16-17) of the mobile device touch sensitive, intuitive hand gestures can be introduced for the aforementioned window switching.

The touch gesture for window switching comprises a single-finger one-directional swipe (or slide) along/against one of the four sides of the mobile device. Evidently, the WNM 710 provided shall make such window-switching gesture very easy, intuitive, and convenient. For example, (i) if the user wants to switch the display to another window of the same application as the current one, she can do the window-switching gesture horizontally along/against the top side 903 or the bottom side 901; and (ii) if the user wants to switch the display to a window of a different active application, she can perform the window-switching gesture vertically along/against the left side 904 or the right side 902. Sometimes, the display page within a window is fully displayed on the display screen 850 (such as the first homepage 712 of FIG. 16 example), in which case the user can do horizontal finger swipe (slide) either along/against the frame side or do it on the display screen surface to switch to another window of the same application (e.g., the second homepage 718 of FIG. 17).

In addition to window switching, the four touch-sensitive sides of the mobile device can be used for 90-degree rotation of the display. The 90-degree display rotation gesture is performed around one of the four corners of the side frame of the device. As shown in FIGS. 23-24, the side frame of the device includes four corners 931, 932, 933, and 934. If, for example, the corner 931 is to be used for a counterclockwise 90-degree display rotation, (i) the user will first put one of her finger at position close to the corner 931 on the bottom side 901; (ii) then she will slide said finger to the right along/against said bottom side 901 until reaching the corner 931; upon which (iii) she will slide said finger upward along/against the right side 902 in a continuous manner. By performing such a counterclockwise 90-degree display rotation gesture, the display 712 in FIG. 23 will be rotated 90 degree in counterclockwise direction, and the resultant display 712 is shown in FIG. 24. Evidently, such a 90-degree display rotation gesture is also very intuitive.

In addition to the foregoing tasks of window switching and 90-degree display rotation, the four touch-sensitive sides of the mobile device can also be used for the task of multi-window display. As used herein and in the annexed Claims, the term “multi-window display” means having more than one windows displayed on the display screen 850 without overlapping. For example, in FIG. 16, the first homepage 712 is displayed on the touch screen 850; in FIG. 17, the second homepage 718 is displayed on the touch screen 850; and in FIG. 18, both the first and the second homepages 712 and 718 are displayed on the screen 850, which is a case of “two-window display” according to the foregoing definition. As for the WNM 710, when both the first and the second homepages 712 and 718 are displayed on the screen 850, the size of the current-window indicator 704 (the dashed box) shall increase horizontally to enclose both the two window boxes of the first row 701 on WNM 710. So the size of the dashed box 704 and the number of the small window boxes within it shall indicate how many windows are currently displayed on the screen 850.

The hand gesture for such a two-window display task (FIG. 18) is a two-finger gesture that is to be performed along/against either the top side 903 or the bottom side 901 of the device. Assuming that the bottom side 901 is to be used, the two-window display gesture comprises the following steps: (i) resting a first finger on/against a point on the bottom side 901 close to (or not far from) the left corner 934; (ii) putting a second finger on/against a point to the right of said first finger on the bottom side 901; and (iii) moving said second finger and said first finger toward one another along/against the bottom side 901 (so such a gesture can be called two-finger “squeezing”). These steps can be repeated in order to have many windows of the same application displayed. Evidently, such a multi-window display gesture is also intuitive. If two windows of two different applications are to be displayed on the screen 850, the foregoing steps (i), (ii), and (iii) shall be performed vertically on/against either the left side 904 or the right side 902 of the device.

It is preferred that, when multiple windows are displayed on the screen 850, the orientation, size, and position of each of these windows will be adjusted automatically such that each one of the windows displayed will not look too thin or narrow. It is also preferred that, when more than two (or three, or four) windows are displayed on the screen, each one of the displayed windows shall be regarded as a single item, meaning that, the GUI will not allow the user to scroll the display content within any of these multiple windows so displayed, but will allow the user to (a) delete such a window (or item) so displayed, or to (b) move the position of such an window (or item) relative to other windows. For example, if the web browser application has a total of 5 windows opened, and when all of these 5 windows are displayed on the screen 850, the user will be able to delete the 2^{nd} window or move the 2^{nd} window to the position of the 5th window, such that the user can have the 1^{st} and 3^{rd} windows displayed together on the screen (by using the reverse of the foregoing gesture of two-finger “squeezing”).

Another benefit of making the four sides of the mobile device touch sensitive is, a group of shortcut gestures can be introduced for quick and easy access to different applications or commands. In the following examples of shortcut gestures, the term “SF” means single-finger tapping on a side of the mobile device; the term “DF” means double-finger tapping on a side of the mobile device; the term “T” means the gesture of tapping once on a side of the mobile device; and the term “B” means a brief break between two tapping gestures. So the term “SF:TBT” means using a single finger to do tapping twice on a side of the mobile device, and there is a brief break between the two tapping gestures. Hence the examples of the foregoing shortcut gestures are, (i) using the gestures “SF:TTT” for displaying the first home page; (ii) using the gestures “DF:TBT” for activating a search engine application; and (iii) using the gestures “DF:TBTBT” for activating an audio text input application, etc.

As it is well known, a mobile device (especially smart phone) is usually provided with a relatively small display screen. Thus, it is preferred that those commonly used window-control, App-interaction, and OS-control tools are included on a general dynamic tool bar 730, as is shown in FIG. 19. By default, the tool bar 730 is hidden “behind” the WNM 710. A touch gesture of horizontal single-finger swipe (or slide) from left to right on the screen 850 is to be employed for “pulling” such tool bar 730 out from behind the WNM 710; And the start point of such horizontal single-finger swipe shall be at the area of WNM 710 so as to distinguish it from the general page-scrolling swipe gesture. In FIG. 19, six tools are included on the tool bar 730, including (a) a window-close tool 731 for closing the current window; (b) a new window tool 732 for creating a new window for the current application, (c) an “undo” tool 733; (d) a “back” tool 734 for going back to a previous view or page; (e) a “forward” tool 735, which is opposite to the “back” tool 734; and (f) a “lock” tool 736 for locking the mobile device when the user want to stop using it for the moment. It is understood that, these six tools on the tool bar 730 are instant-action tools, which means when any of these tools is selected, it will cause an instant action. The tool bar 730 will be automatically hidden again after one of the six tools is used or selected.

Again, when the user decides to stop using the mobile device 900 for the moment, she can select the lock tool 736 on the tool bar 730, upon which a combination lock 770 shall be activated and displayed on the screen 850, as is shown in FIG. 21. The combination lock 770 comprises six wheels, and thus it is called six-digit lock herein. But this does not means that the user has to spin each one of these six wheels to the right position in order to open the lock 770. For example, during the setup process, the user can decides that only the second wheel 772 and the fourth wheel 774 shall be used, and the positions of the other four wheels are not pertinent to opening the lock 770. In this way, even though the combination lock 770 includes six wheels, the user only needs to spin the second wheel 772 and the fourth wheel 774 to the respective right positions in order to open the lock 770, making such a task much easier without compromising the security. This is because, to other people who do not know such a “secret”, the level of difficulty of trying to open the lock 770 is the same as that of a real six-digit lock. If the user misplaces or lose the mobile device (smart phone), she can use another smart phone to send a predetermined special text message to it for activating a long-digit lock.

As it is well known, touch gestures are the primary user input/interaction means of a mobile device, because it is convenient and intuitive. But the conventional mobile-device touch gestures provide less functional features than the traditional mouse-keyboard system. Accordingly, an object of the present invention is to substantially increase the functional features of a mobile-device's touch gestures. As shown in FIG. 22, a hand-gesture tool panel 610 is provided, which includes seven hand-gesture tools 611, 612, 614, 615, 616, 617, and 618. While the system is at the default state, the panel 610 is hidden “behind” the WNM 710. A touch gesture of vertical single-finger swipe in upward direction on the screen 850 is to be employed for “pulling” such panel 610 out from behind the WNM 710; and the start point of such vertical single-finger swipe shall be at the area of WNM 710 so as to distinguish it from the general page-scrolling gesture. After any of these seven tools is selected, only the icon of the selected tool will be displayed above the WNM 710, and all other tools will become hidden again.

In the example of FIGS. 23 and 24, the WNM-interaction tool 612 on the panel 610 of FIG. 22 is selected, upon which (i) the icon 612 is displayed above the WNM 710; (ii) all other icons on the panel 610 will become hidden again; and (iii) the WNM 710 is enlarged in response to the selection of the tool 612 such that the user can use her finger to move the dashed box 704 to a different window box within the WNM 710 for the purpose of having the window associated with said different window box moved onto the display screen 850. If the user wants to return to the default hand gesture state, she can push the icon 612 downward toward the WNM 710 to hide it, upon which the WNM 710 will return to its default form in response.

In the example of FIG. 25, a text web page 621 is displayed on the screen 850; and the text search tool 614 on the panel 610 of FIG. 22 is selected, upon which the icon 614 and a text box 622 is displayed above the WNM 710, and all other icons on the panel 610 become hidden again. After the user enter the word “direction” into the text box 622, the display 850 will highlight the three positions of the text “direction” on the text web page 621. If the user wants to return to the default state, she can push the icon 614 and the text box 622 downward toward the WNM 710 to hide them.

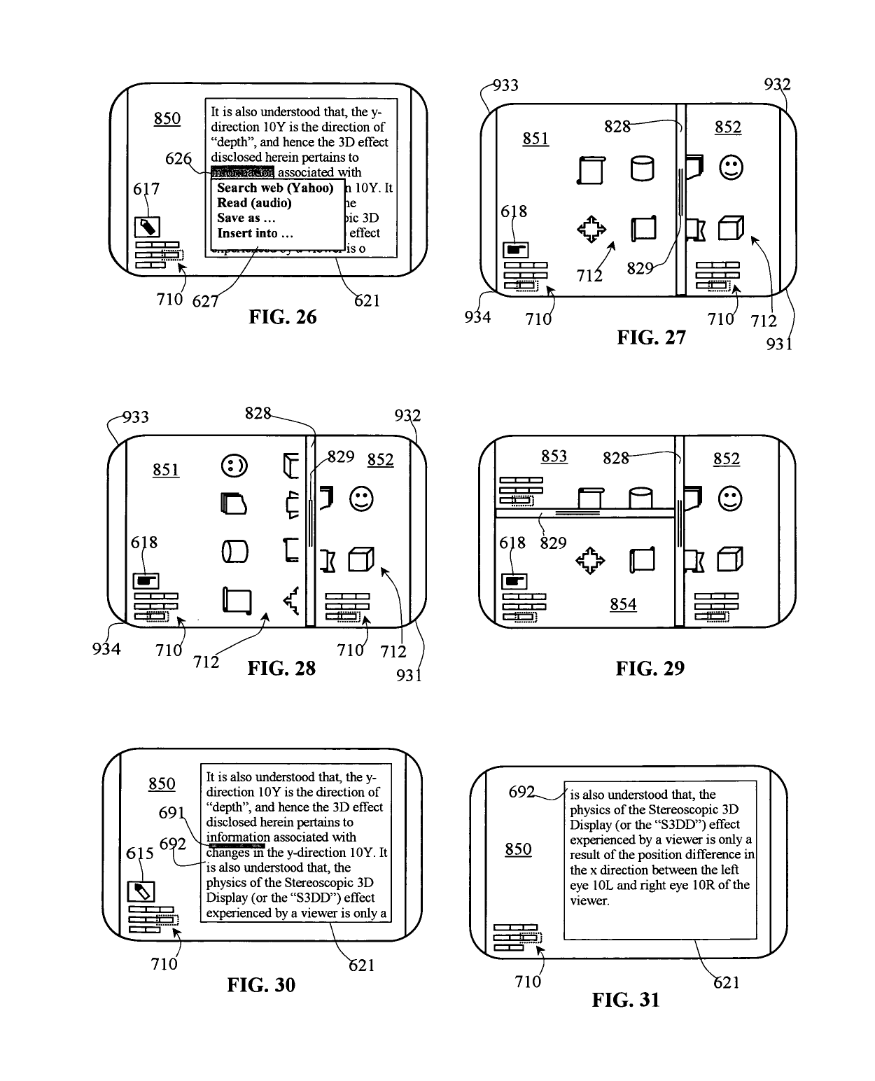

In the example of FIG. 26, a text page 621 is displayed on the screen 850, and the text and object selection tool 617 on the panel 610 of FIG. 22 is selected, upon which the function of the conventional touch gesture is changed to text or object selection. Thereafter, the user can use a single-finger touch gesture to select the text “information” 626 within the text page 621. The tool 617 can also be used for selecting an image (or other type of object displayed) by drawing a rectangle around such an image. Then by tapping on the selected area 626, a menu 627 is displayed. The menu 627 includes a list of options in connection with the selected text 626, such as searching the web for the selected text 626, or reading the selected text 626. If the user wants to return to the default hand gesture function, she can push the icon 617 downward toward the WNM 710 to hide it.

In the example of FIG. 30, a text page 621 is displayed on the screen 850, and the marker tool 615 on the panel 610 of FIG. 22 is selected, upon which the function of the conventional touch gesture is changed, allowing the user to make a mark (or highlight) 691 at any point on the display page 621, so as to (i) highlight the interesting point(s) on the page 621, and to (ii) make it easy for returning back to the same page view during scrolling. In FIG. 31, after pushing the icon 615 downward toward the WNM 710 to hide it, the default touch gesture function of scrolling the page 621 has been returned. Then when the user scrolls the text page upward, the lower-middle position 692 of the page view 621 of FIG. 30 is moved to the top of the page view 621 in FIG. 31; and thus the mark 691 above the position 692 becomes hidden. Thereafter, if the user wants to have the text page view 621 quickly return to the view of FIG. 30, she can simply scroll the page 621 downward. Because of the existence of the mark 691, even if her downward scrolling gesture is fast, the text page will always return to or stop at the page view position 621 of FIG. 30 first, which is the page view position when the mark 691 was first put on the page 621. Thereafter user can always do further downward scrolling. It is preferred that the mark 691 is a temporary mark, meaning that it will not be automatically save into the corresponding file. If the corresponding application is closed and then re-activated at a later time to view the same text page 621, the mark 691 will disappear.

In the example of FIGS. 27-29, the glass cutter tool 618 on the panel 610 of FIG. 22 is selected to assign the “glass-cutting” function to the conventional single-finger touch gesture. The function of the glass cutter 618 is to divide or “cut” the screen 850 into multiple pieces. After such tool 618 is selected, the user's finger will function like a cutter. In the example of FIG. 27, when the user slide one of her finger along the line 828, the screen 850 of FIG. 22 is cut into two independent screen sections 851 and 852. It is preferred that a WNM 710 is always shown at the lower-left corner of each screen section so formed. Thereafter, (i) the change of window or application within the left screen section 851 will not affect the display within the right section 852, and vice versa, provided that the user is allowed to move an item across from the left screen section 851 to the right section 852 (if the corresponding application is compatible), and vice versa; (ii) the change of display orientation within the left screen section 851 will not affect the display within the right section 852 either, and vice versa. The separator 828 separating the two screen sections includes a handle 829 for allowing the user to move the separator 828 to the left or right. If the foregoing counterclockwise 90-degree display-rotation gesture is performed around the corner 933 or 934, then the display within the screen section 851 of FIG. 27 will be rotated counterclockwise by 90 degree, as is shown in FIG. 28. But if the 90-degree display rotation gesture is performed around the corner 932 or 931 instead, then the display within the screen section 852 of FIG. 27 will be rotated because the corners 931 and 932 are the corners of the screen section 852 (not section 851). In the example of FIG. 29, the left screen section 851 of FIG. 27 is further cut or divided into two sections 854 and 853 by sliding a finger along the line 829. So the entire screen comprises three pieces: 852, 853, and 854. If the user wants to return to the default hand gesture function, she can push the icon 618 downward toward the WNM 710 to hide it.

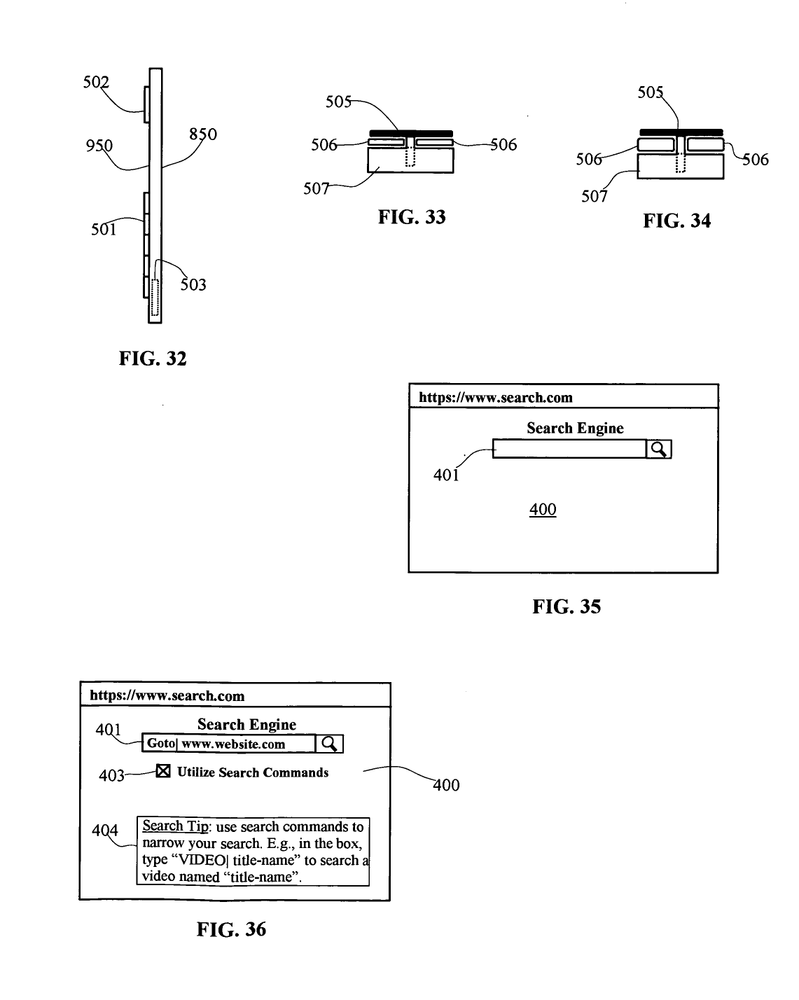

Referring now to FIGS. 32-34, in order to provide a user with better typing experience, a physical keyboard 501 and a secondary display screen 502 may be installed on the back panel 950 of the mobile device, as is shown in FIG. 32. The secondary display screen 502 is provided for allowing the user to see the texts being typed in. Moreover, the user's typing experience can be further improved by providing the keyboard 501 with a pneumatic cushion mechanism. FIGS. 33 and 34 are enlarged cross-sectional views of one of the keys of the keyboard 501 of FIG. 32. As shown therein, there is a pneumatic layer 506 between the top of the key 505 and the body of the device 507. FIG. 33 illustrates the situation where there is no air pressure within the layer 506, and FIG. 34 illustrates the situation where the pneumatic layer 506 is provided with adequate air pressure. Such air pressure is controlled by a pneumatic pump 503 installed within the body of the mobile device. It is understood that, such a method of providing the keyboard 501 with a pneumatic cushion mechanism can be applied to any type of keyboard.

Referring now to FIGS. 35 and 36, the last part of the present invention pertains to the method of improving a web search engine and its homepage display. FIG. 35 is an exemplary prior art search engine homepage 400, which includes a search box 401 for allowing a user to type in the desired search terms or the like. As it is well known, in the prior art, everything typed into the search box 401 is treated as a portion of the search term. One drawback of such a prior art design is, there are many words that are better used for narrowing the search than being treated as part of the search terms. For example, if the simple word/phrase “locate”, “goto”, or “buy” is typed into the search box 401 and is treated as a part of a search term, it usually does not provide the search engine with any useful information with respect to the user's true intention (unless the user wants to treat it as a portion of a text string). So it is better to use these words/phrases to narrow the search. According to the present invention, the word/phrase “locate”, “goto”, or “buy”, etc., can be treated as a search command for the purpose of narrowing the web search.

On the homepage 400 of the search engine, a check box 403 is provided for allowing the search engine to recognize these search commands, as is shown in FIG. 36. In this example of FIG. 36, after the box 403 is checked, and if the phrase “goto” is typed into the search box 401 first, followed by a web address, then it will instruct the search engine to locate such a web address. So if the box 403 is checked, the first word (or phrase) typed into the search box 401 will be treated as a search command for narrowing the search. If the box 403 is not checked in FIG. 36, then the phrase “goto” typed into the search box 401 will be treated as a portion of a search term. Similarly, if the box 403 is checked, and the word “locate” is typed into the search box 401 first, followed by an address of a building in a city, it will instruct the search engine to search or locate such address on the map. Alternatively, a search-command dictionary may be established such that the search engine will only recognize a search command if it can be found in said search-command dictionary.

Therefore, by employing or including the check box 403 on the search engine homepage 400, the search engine can be provided with unlimited number of search commands. Other examples of such type of search commands are: (a) “video”, which is to be followed by a video title, (b) “author”, which is to be followed by a person's name, (c) “book”, which is to be followed by a book title/name, (d) “file”, which is to be followed by a file name, (e) “eat”, which is to be followed by a restaurant name (and city name), (f) “game”, which is to be followed by a computer game title, (g) “news”, which is to be followed by one or more words, (h) “image”, (i) “article”, (j) “ticket”, which is to be followed by the name/title of a movie, show, or sports game, etc., (k) the name or trademark of a company or business entity, (l) the name of a city, which is to be followed by a business category name (e.g., “Dallas hotel”, which will instruct the search engine to search for hotels in the city of Dallas), etc.

Evidently, the search engine can also be provided with more complex search commands or search formats to facilitate more sophisticated search. On the other hand, an average user usually is not familiar with most of these search commands or search formats. Therefore, according to the present invention, the search engine homepage 400 may include a search tip section 404 for providing search tips to the user.

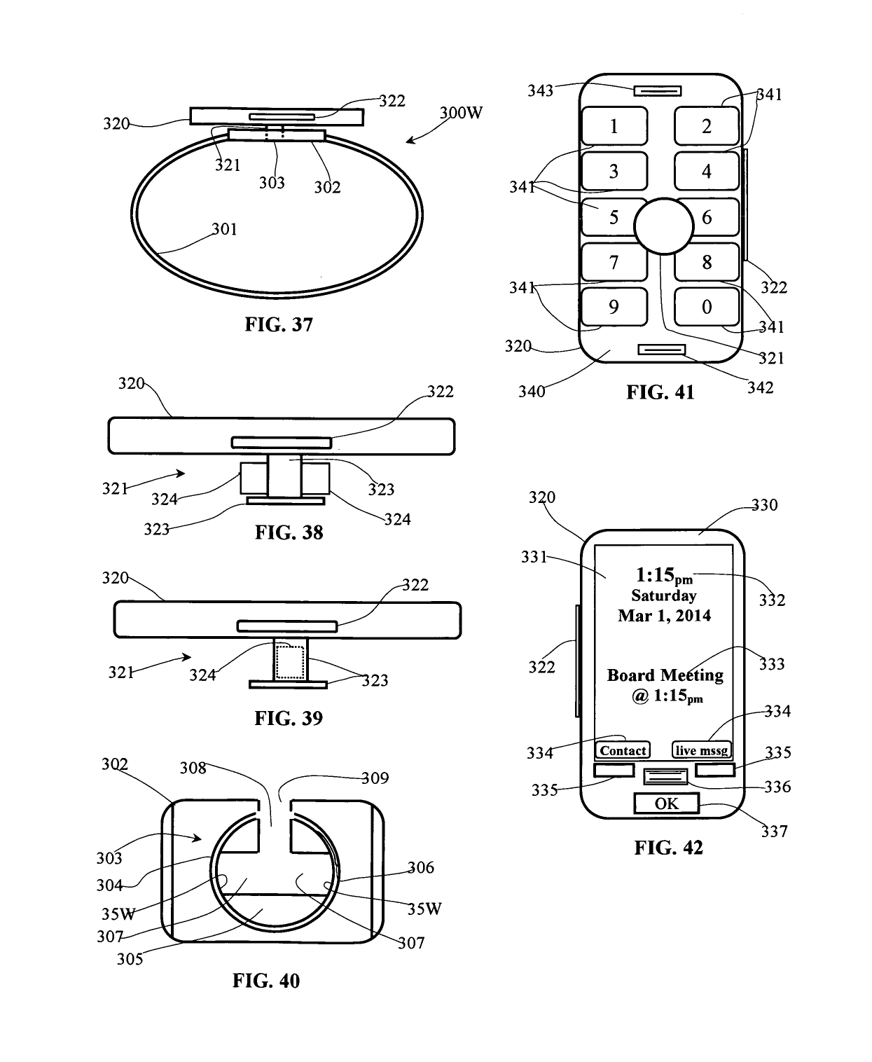

Reference is now made to FIGS. 37-42. As it is well known, in the current marketplace of mobile computing devices, a smart phone and a tablet computer are generally regarded as different type of personal mobile devices, even though most of the other features and the operating systems of the two types of devices are very similar. This is because, a tablet computer usually is not provided with any mobile-phone functionality, since it is not convenient for a user to hold a tablet computer of the size of seven or nine inches onto her ear for making phone calls. On the other hand, the reason the tablet computer market exists is precisely because of its large touch screen size, which allows a user to perform many tasks much better or more conveniently than using a smart phone.

According to the present invention, a phone/watch device can be provided as a peripheral device of a mobile computing device (such as a tablet computer or a large smart phone). The standard Bluetooth technology can be used for the connection between the phone/watch device and the mobile computing device. A key difference between the present invention and the prior art Bluetooth watch is, the phone/watch of the present invention can be easily detached from its wristband or watchband base such that, a user can use it either as a smart wrist watch when it is attached to the wristband base, or as a cell phone when it is detached from the wristband.

As shown in FIG. 37, the basic components of a phone/watch device 300W of the present invention include a phone/watch body 320, a wristband 301, and a base 302 which is affixed to the wristband 301. The phone/watch body 320 includes a base-engagement mechanism 321. The base 302 includes a phone/watch-engagement mechanism 303 for engaging with the element 321 of the phone/watch body 320. In FIG. 37, the phone/watch body 320 also includes a detaching mechanism 322 for detaching the engagement between the elements 321 and 303. Alternatively, detaching mechanism 322 may be provided on the base 302.

The front panel 330 of the phone/watch body 320 includes a display screen 331 (FIG. 42). In default mode, when there is no incoming phone call or text messages or the like, the display screen 331 will show the current time and date information 332, as is the function of a regular watch. In addition, while in such default mode, the display screen 331 may also show other live information, such as calendar schedule information 333, etc. The front panel 330 of the FIG. 42 example also includes (i) two soft keys 335, and their functions are directly associated with the display icons 334 at the bottom of the display 331 respectively; (ii) a regular “OK” or action key 337, and (iii) a browsing/scrolling wheel 336 for scrolling through the contents to be displayed on the screen 331.

When there is an incoming call, the display screen 331 will show the name and/or the phone number of the caller, and one of the soft keys 335 will be assigned to the function of rejecting the incoming call. If the user wants to answer, she can just hold the detaching bar 322 to release the watch/phone body 320 from the base 302, and hold it to one of his ears. It is not necessary to press the OK key 337 before or after holding the detaching bar 322 in order to answer an incoming call.

FIG. 41 shows an exemplary back panel 340 of the watch/phone body 320 of FIG. 37. As shown, the back panel 340 includes (i) ten number/letter (physical) buttons or keys 341, (ii) the aforementioned base-engagement mechanism 321, (iii) the conventional phone mouthpiece (transmitter) opening 342 and earphone (receiver) opening 343. The user may use the number keys 341 to dial a phone number. Alternatively, a small display screen may be provided at the back panel 340 to show to the user the number being pressed.

FIGS. 38 and 39 are side views of an exemplary base-engagement mechanism 321 of the phone/watch body 320. As shown, the base-engagement mechanism 321 includes a short supporting post 323 and two engaging blades 324. When the detaching bar 322 is pressed by the user, the two engaging blades 324 will be drawn to the inside of the supporting post 323 (FIG. 39); When the detaching bar 322 is not pressed by the user, which is the default state, the two engaging blades 324 will be pushed out of the supporting post 323 (FIG. 38) by a spring mechanism (not shown).

In FIG. 40, in association with the exemplary base-engagement mechanism 321 of FIGS. 38 and 39, the engagement mechanism 303 of the base 302 includes a socket or aperture 304. A disk 305 is contained and supported by the aperture 304. The disk 305 can rotate with respect to the aperture 304 and the base 302; and a spring mechanism 306 is provided to urge the disk 305 to its default position with respect to the aperture 304. The disk 305 has opening (void) portions 307 and 308, and the base 302 also has an opening (void) portion 309 connecting to the opening 308 of the disk 305 when the disk 305 is at its default position. When the engaging blade 324 are drawn to the inside of the supporting post 323, the user will be able to move the supporting post 323 into and out of the opening 307 of the base 302 through the openings 308 of the disk 305 and the opening 309 of the base body 302. When the supporting post 324 is situated inside the opening 307 of the disk 305, releasing the detaching bar 322 will allow the two engaging blades 324 to press against the interior walls 35W of the disk 305 such that the phone/watch body 320 is completely or fully engaged with the base 302.

Such an engagement mechanism of the example of FIGS. 38-40 allows the user to (i) easily rotate the phone/watch body 320 with respect to the base 302, so as to easily have the landscape view of the display screen 331; and to (ii) easily attach the phone/watch body 320 to or detach it from the base 302, so that the phone/watch body 320 can be used as a watch and a phone. It is understood that a switching mechanism may be provided such that, when the phone/watch body 320 is rotated with respect to the base 302, the display 331 (FIG. 42) will automatically be changed to landscape view.

It is also understood that, the phone/watch body 320 may also be used as a remote-control device for controlling the corresponding tablet computer or smart phone, especially when it is detached from the base 302. This remote-control function is particular useful in situations such as when the user wants to use the tablet computer or smart phone to take a picture with “everybody” included, or to watch a video, etc.

Cloud-Based OS

Another aspect of the present invention pertains to the concept of Cloud-Based Operating System (the Cloud-based OS) of a personal computing device. The term personal computing device, as used herein, maybe a traditional computer or the like, or it may be a mobile computing device such as a laptop computer, smart phone, or tablet computer, or the likes. A fundamental of the Cloud-based OS concept of the present invention is to establish “Permanent Connection” or “Permanent Association” between the local client account of the user and a (primary) web account of the user.

Traditionally, in the prior art OS, a permanent connection/association between a local client and a (primary) web account of the user means the user needs to fully log in to the user's web account (by using the username or user-ID and password combination, which usually employs encryption), and to remain in such logged-in states “permanently”. Obviously, there is substantially security risk for such permanently logged-in practice.

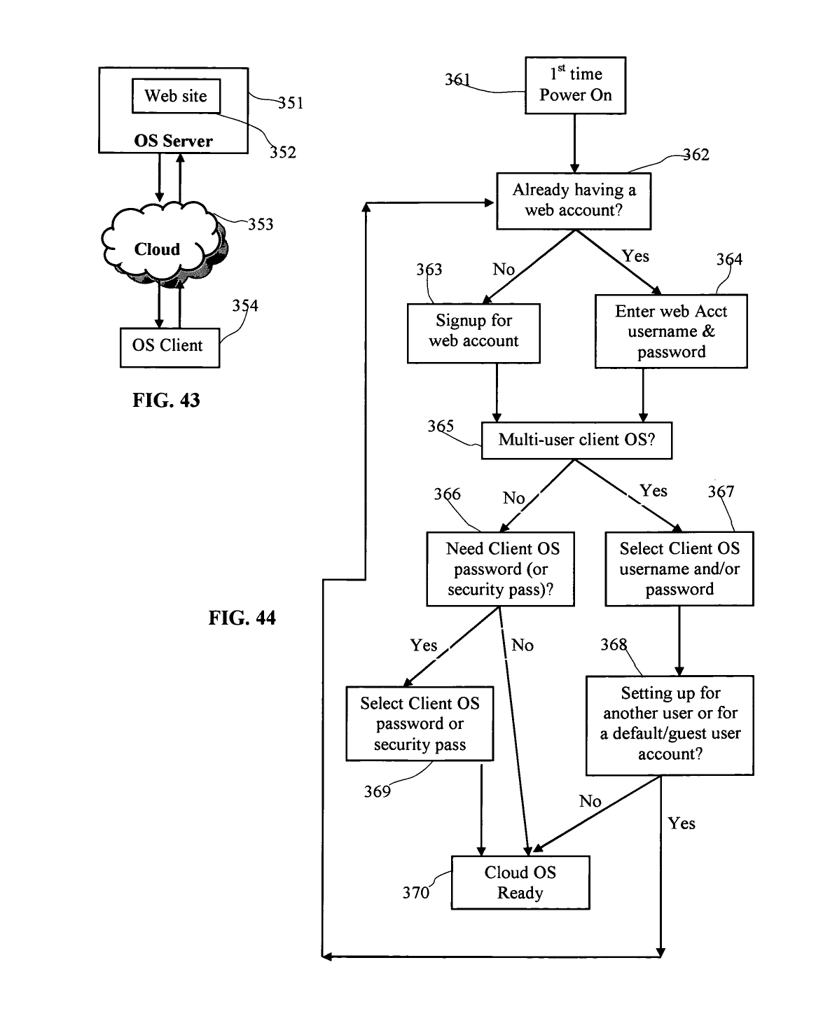

According to the present invention, another type of logged-in state, called “Cloud-based-OS Logged-In” state, can be established as follows. When the user's web account remains in such Cloud-based-OS Logged-In state, in addition to the (Primary) username or user ID of the web account, a secondary user ID will be created and saved in the client system 354 (see FIG. 43). A simply way to do this is to save such secondary user ID as a cookie. Certainly more secure way can be used at OS level. Moreover, such a secondary user ID shall be changed dynamically (regularly) in order to improve the security. The purpose of providing such secondary user ID is for establishing said (permanent) Cloud-based-OS Logged-In” state, during which the client OS 354 will constantly send such secondary user ID to a corresponding OS Server 351 for identification purpose. Then the Cloud-based-OS server 351 and the web site 352 associated therewith will provide the client 354 with Cloud-based-OS related services accordingly. Such a secondary user ID will not be displayed when the user is conducting any online activities.

Therefore, according to the present invention, a user's web account can be provided with three levels of log-in state, (i) the conventional completely unlogged-in state, in which case the user will not be allowed to have access to any information related to his web account; (ii) the conventional fully logged-in state, in which case the user will be allowed to have full access to his web account, including access to all personal information AND changing or editing the settings, preferences, passwords, or personal profile, etc., of his web account; (iii) Cloud-based-OS Logged-In state, in which case the use will NOT be allowed to perform vital tasks such as changing or editing the settings, preferences, passwords, profile, etc., of his web account; but the server OS 351 will be allowed to send certain pieces of personal information to the client OS 354, provided that, the user will have the option to choose what personal information shall be sent from the OS server 351 to the Client 354 while in such Cloud-based-OS Logged-In state. It is also preferred that, when the client 354 remains in such Cloud-based-OS Logged-In state longer than a predetermined amount of time, the user will be prompted to enter the username and password (employing encryption) of the corresponding web account.

An advantage of providing such Cloud-based OS-Logged-In state for a user's web account is, many types of personal information that are deemed not very sensitive can be “safely” displayed on the client computer 354's start or home screen (or desktop, or the like). For examples, social-network related information, such as the updates of the recent activities of the user's best friends, the updates of subscribed information (such as news, pack delivery status, schedules of any major event, payment overdue alert, etc.), updates of a status of a web service, etc., can be displayed on the client computer 354's start or home screen (or desktop, or the like) without causing any security concern by the user. Accordingly, a live Home-/start-screen web page can be established to allow the user to choose which piece of information is to be displayed on the desktop or start screen live.

The process of setting up the Cloud-Based OS account is simple. As shown in FIG. 44, when a user has a new computing device, for example, after turning on the power for the first time, at step 361, the user will be asked if she already has an web account with the web site 352 (FIG. 43) at step 362. If the answer to step 362 is “Yes”, then at step 364, the user will be asked to enter the account username and password of her web account; If the answer to step 362 is “No”, the user will be asked to sign up for an account with the web site 351. Then at step 365, the system will determine if the computing device is a multi-user device. For example, a smart phone is usually not a multi-user computing device, whereas a desktop computer is usually a multi-user computing device.

If the answer to step 365 is “Yes”, then at step 367, the user will be asked to select username and/or password for the client OS 354. Such client username/password may be the same as or different from those of the user's web account. Then at step 368, the system will ask the user if she wants to set up a Cloud-Based OS account for another user or for any guest user (or the default account). If the answer to step 368 is “No”, then it will reach the end 370 of the process, and the Cloud-Based OS client 354 is ready for use. If the answer to step 368 is “Yes”, then the process will go back to step 362.

If the answer to step 365 is “No”, then at step 366, the user will be asked if she needs any form of security pass for her computing device. If the answer to step 366 is “No”, then it will reach the end 370 of the process, and the Cloud-Based OS client 354 is ready for use. If the answer to step 366 is “Yes”, then at step 369, the user will be asked to select pass code or the like for her computing device before moving to the end 370.

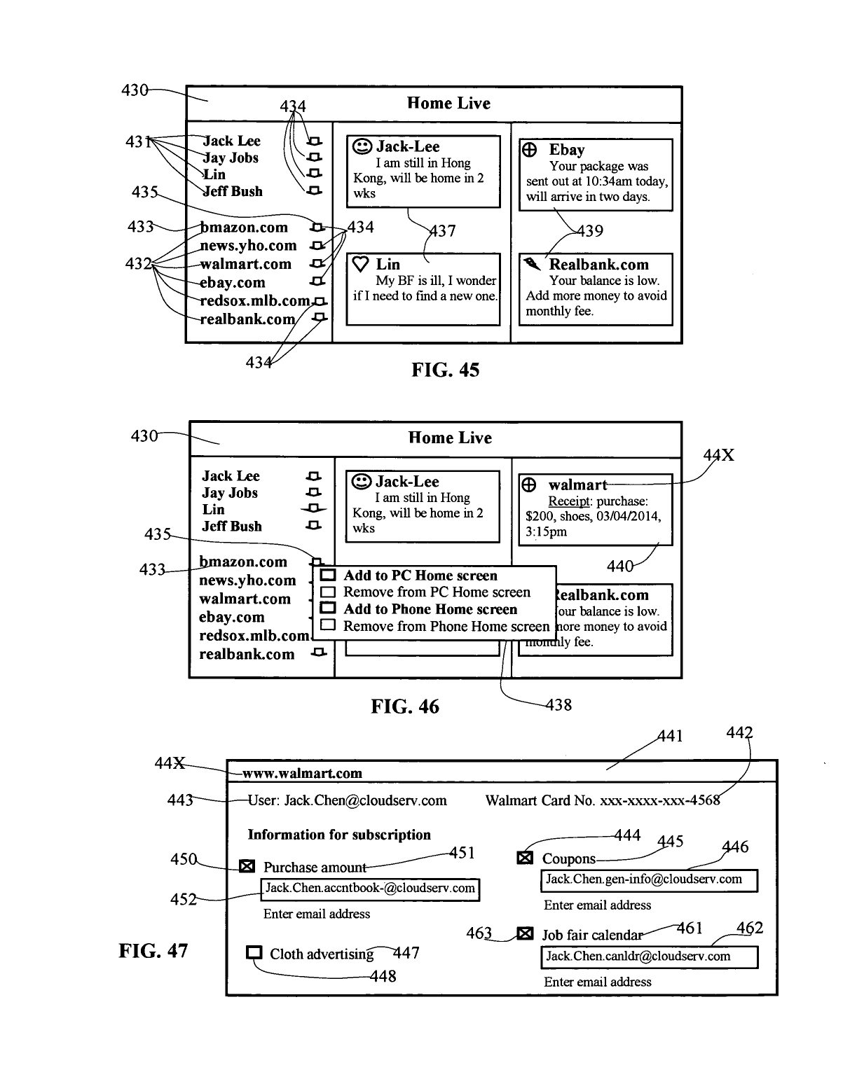

Again, a live home-screen (or start screen) web page 430 (FIGS. 45 and 46) can be provided for allowing the user to select which pieces of live information are to be displayed on her personal computing device's home or start screen or the like. In the example of FIG. 45, the live information on the Live Home web page 430 includes live messages 437 and 439. The left portion of the web page 430 includes (i) a list of the user's friends 431, whose live update messages can be shown on the web page 430 as 437, and (ii) a list of service providers 432, whose live update messages can be shown on the web page 430 as 439, including the service provider 433. As shown, (I) a drop-menu button 434 is provided next to the name/ID 431 of each one of the user's friends; and similarly (II) a drop-menu button 434 is provided next to the name/ID 432 of each one of the user's service provider. For example, the drop-menu button 435 is associated with the service provider 433. In FIG. 46, the button 435 associated with the service provider 433 is clicked by the user. In response thereto, a drop menu 438 associated with the item 433 is displayed, which allows the user to select whether to include the personal live message from the service provider 433 on the home screen(s) of her smart phone, her personal computer, and/or her tablet computer, etc.

As shown in FIG. 45, the two live messages 437 are the typical social-network messages. In order to receive such type of social-network messages by the user of the client 354, the user needs to either include the message provider as her “friend” (or the like), OR have the message provider include the user as his/her friend (or the like). Such type of social-network messaging method is very well known. In FIG. 45, the two messages 439 are different from said social-network message 437, because the two messages 439 are received from two service providers, respectively. Usually a service provider only allows a general user to receive general (non-personal) information through the conventional social network system.

One aspect of the present invention pertains to how to easily receive live message that is personal to the user from any service provider. This is realized by adding a unique “extension” to the user's primary email address for receiving a specific type of live message, such that different types of live messages received from a service provider can be “treated” differently.

In the example of FIG. 46, the live message 440 is received from a service provider 44X, which is a merchant. In association therewith, FIG. 47 is an exemplary information subscription page 441 provided by the service provider 44X (this is after the user logged into her account with the service provider 44X). In FIG. 47, the user's email address 443 (displayed for identification purpose) is the user's primary email address associated with his Cloud-Based-OS user account and supported by the Cloud-Based-OS server web site 351/352 (FIG. 43). On web page 441, there are four pieces information that are available for user subscriptions, including (i) Purchase amount 451, which is associated with a check box 450, (ii) Coupons 445, which is associated with a check box 444, (iii) cloth advertising messages 447, which is associated with a check box 448, and (iv) job fair calendar 461, which is associated with a check box 463. If the user wants to subscribe a specific piece of information, he will click on the corresponding check box and then enter the “CORRECT” email address. For example, when the user checks on the check box 444, then the box 446 will be displayed, after which the user will enter the subscription email address “Jack.Chen.gen-info@cloudserv.com”, which has an extension “gen-info” compared with the user's primary email address “Jack.Chen@cloudserv.com”. After such a setup, the service provider will just sent the Coupon info 445 to the email address provided in the box 446. When the Cloud-Based-OS server 351/352 receive the coupons message 445 from the service provider 44X, because of the extension “gen-info”, the coupons message 445 will not be shown in the user's email inbox; Instead, it will be shown on the user's live home page 430 (FIG. 45).

According to the present invention, the method of using email-address extension can also be used for determining which specific application is to be used for receiving the live message subscribed from a service provider (i.e., App-specific subscription). In the example of FIGS. 47 and 49, when the check box 463 is checked, then the “job fair calendar” information 461 will be sent to the email address “Jack.Chen.canldr@cloudserv.com”, which is provided in the box 462, and which has an extension “canldr”. When the Cloud-Based-OS server 351/352 receives the calendar information 462 from the service provider 44X, because of the extension “canldr”, the Job fair calendar information 461 will not be shown in the user's email inbox; Instead, it will be shown in the user's Cloud-OS-based calendar application 470. In FIG. 49, the three calendar/schedule entries 471 were entered by the user by hand, and the entry 472 were entered automatically through the subscription of the calendar information 461 of FIG. 47. As shown, the entry 472 includes the body 476 of the message and the source information 473 thereof.

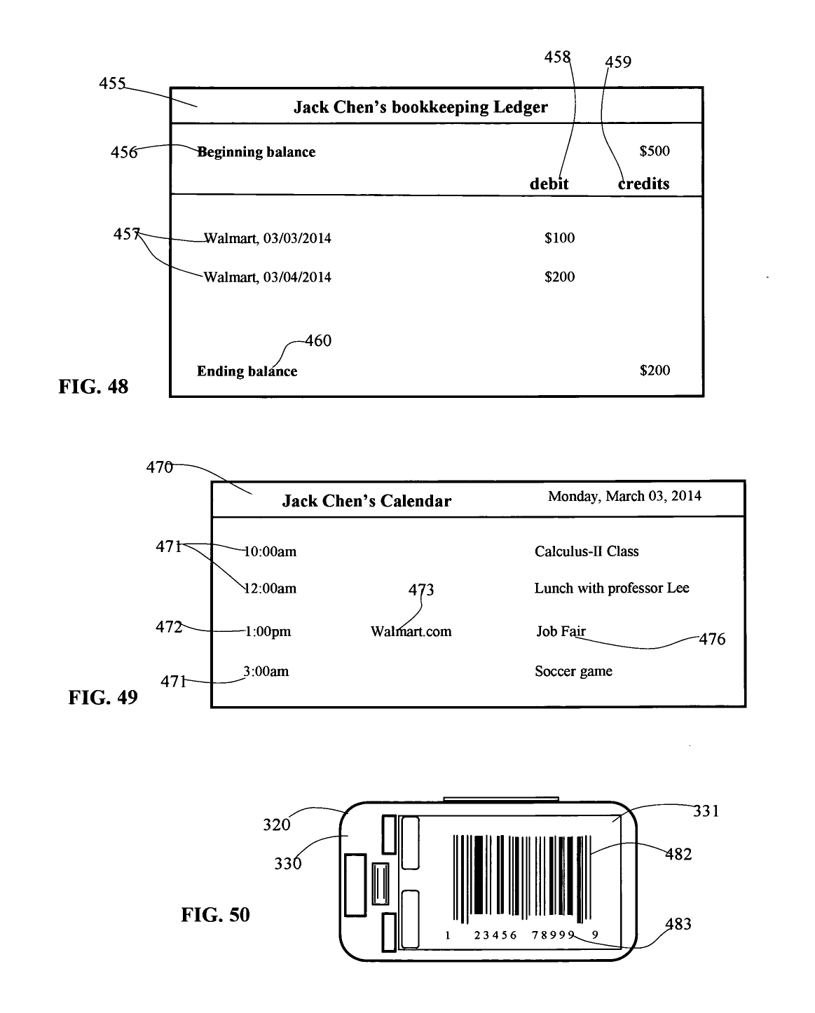

Similar to the calendar app of FIG. 49, FIG. 48 is a Cloud-OS-based book-keeping ledger application 455. In FIG. 47, when the check box 450 is checked, then the “Purchase amount” information 451 will be sent to the email address “Jack.Chen.accntbook-@cloudserv.com”, which is provided in the box 452, and which has an extension “accntbook-”. The “Purchase amount” information 451 is the amount of money the user spent at the service provider 44X's local stores, which is tracked by the user's member-card number 442. When the Cloud-Based-OS server 351/352 receives the “Purchase amount” information 451 from the server, because of the extension “accntbook-”, the “Purchase amount” information 451 will not be shown in the user's email inbox; Instead, it will be shown in the user's Cloud-OS-based book-keeping ledger application 455. In FIG. 48, the ledger book entries 457 were both entered automatically through the subscription of the “Purchase amount” information 451 of FIG. 47.

Alternatively, more than one email addresses can be used for subscription of a specific live message. For example, in FIG. 47, when the check box 450 is checked, two email boxes can be displayed under the message title 451, allowing the user to enter two subscription email addresses. If, for example, the user enters the email addresses “Jack.Chen.accntbook-@cloudserv.com” and “Jack.Chen.gen-info@cloudserv.com” in said two email boxes under the message title 451, respectively, then the corresponding purchasing information will be displayed both in the Cloud-OS-based ledger application 455 (FIG. 48) AND on the “Home Live” web page (FIG. 45), so the user will have the option to put such info on the Home screen of any of his computing device.

According to another aspect of the present invention, a barcode creation/display client application may be provided. Such a barcode creation/display app, together with the foregoing method of displaying live information on the home (or start) screen of a user's computing device, can be used for providing immediate cloud-based electronic purchasing receipt on a user's mobile device. The barcode creation/display client app can also be used for using a mobile device, such as a smart phone, to make payment at a merchant retail store.

Referring now to FIG. 50, similar to FIG. 42, the front panel 330 of a mobile device 320 includes a display screen 331. When said barcode creation/display client application is executed, a barcode 482 is displayed on the screen 331, together with the corresponding number 483. The creation of the barcode 482 is based on the number 483 that needs to be entered by the user.

Obviously, such type of mobile-device barcode app may be used in many ways. For examples (i) the barcode number 483 can be the user's credit card number; And when such a credit-card number barcode is displayed on the mobile device, the user can use it to make credit-card payment at any of the retail store that is provided with barcode scanner capability at the cash register. Comparing with the prior art method of using mobile device to make payment at retail stores, a key advantage of the mobile-device barcode app of the present invention is, it does not require the retailers or merchants to substantially change their physical infrastructure or the like; it only require the retailer/merchant to change the “setting” of its existing cash-resister system. (ii) the barcode number 483 can be the user's membership number 442 (FIG. 47) associated with the merchant or retailer 44X. So in the foregoing example associated with FIG. 47, when the user enter the email address “Jack.Chen.gen-info@cloudserv.com” in the box 452 under the “Purchase amount” information 451, then an electronic receipt 440 for the user's payment will be sent to the Cloud-based-OS server 351, and such an electronic receipt 440 will be shown on the “Home Live” web page 430 (FIG. 46). Moreover, in the foregoing example associated with FIGS. 45 and 46, if the user had chosen to allow messages from the service provider 44X, “walmart.com”, to be displayed live on his mobile-device home screen, then said electronic purchasing receipt 440 would be displayed on the user's mobile-device home screen soon after the purchase was made. Again, the user can enter more than one email address under the live-message title 451.

In summary, because the barcode scanner functionality is widely used in retailers/merchant industries, a barcode creation/display client application can be used in many ways, and will provide many forms of convenience to the users and the retailers.

1. A method for constructing a stereoscopic 3D model comprising a pre-determined primary 3D model and a secondary 3D model, said stereoscopic 3D model representing an object image situated at a virtual first 3D position, said object image being presented, via a display screen, to an viewer having a left eye situated at a second 3D position and a right eye situated at a third 3D position, said method for constructing said stereoscopic 3D model comprising the steps of constructing said secondary 3D model by modifying a copy of said pre-determined primary 3D model, said step of modifying said copy comprising the steps of:
Rotating said copy by an angular amount; and
Displacing said copy by a displacement amount;
Said angular amount being determined by a geometric triangle formed by said first 3D position, said second 3D position, and said third 3D position, said displacement amount being determined by said geometric triangle and the position of said display screen.

2. A method for constructing a stereoscopic 3D model representing a plurality of object images, said plurality of object images being situated at a plurality of virtual 3D positions respectively, each one of said plurality of object images being represented by a pre-determined primary 3D model and a secondary 3D model, said plurality of object images being presented, via a display screen, to an viewer having a left eye situated at a second 3D position and a right eye situated at a third 3D position, said method for constructing said stereoscopic 3D model comprising the steps of constructing said secondary 3D model associated with said each one of said plurality of object images by modifying a copy of said pre-determined primary 3D model, said step of modifying said copy comprising the steps of:
Rotating said copy by an angular amount; and
Displacing said copy by a displacement amount;
Said angular amount being determined by a geometric triangle formed by said virtual 3D position associated with said each one of said plurality of object images, said second 3D position, and said third 3D position, said displacement amount being determined by said geometric triangle and the position of said display screen.

3. A method for constructing a stereoscopic 3D model comprising a pre-determined primary 3D model and a secondary 3D model for representing a large object image, said object image being presented, via a display screen, to an viewer having a left eye situated at a second 3D position and a right eye situated at a third 3D position, said method for constructing said stereoscopic 3D model comprising the steps of constructing said secondary 3D model by modifying a copy of said pre-determined primary 3D model, said step of modifying said copy comprising the steps of:
Dividing said primary 3D model and said copy into a plurality of sub-models,
Determining the virtual 3D position of each one of said sub-models of said primary 3D,
Rotating a sub-model of said copy, associated with said each one of said sub-models of said primary 3D, by an angular amount, and
Displacing said sub-model of said copy associated with said each one of said sub-models of said primary 3D by an displacement amount, Said angular amount being determined by a geometric triangle formed by said virtual 3D position, said second 3D position, and said third 3D position, said displacement amount being determined by said geometric triangle and the position of said display screen
